(19) United States
(12) Patent Application Publication
(10) Pub. No.: US 2023/0035195 A1
(43) Pub. Date: Feb. 2, 2023

(54) METHOD FOR TREATING A PLANT

(71) Applicant: RHODIA OPERATIONS, Lyon (FR)

(72) Inventors: Franck Aurissergues, Argenteuil (FR); Lidiane De Oliveira, Valinhos (BR); Thierry Le Mercier, Rosny-Sous-Bois (FR); Lauriane D'Alencon, Issy-Les-Moulineaux (FR)

(73) Assignee: RHODIA OPERATIONS, Lyon (FR)

(21) Appl. No.: 17/786,667

(22) PCT Filed: Dec. 16, 2020
(86) PCT No.: PCT/EP2020/086345

§ 371 Date: Jun. 17, 2022

(30) Foreign Application Priority Data
Dec. 19, 2019 (EP) 19315166.9

(51) Int. Cl. C09K 11/02; C05G 3/60; C05G 5/27; C05G 3/50; C09K 11/77

(52) U.S. Cl. CPC C09K 11/025; C05G 3/60; C05G 5/27; C05G 3/50; C09K 11/7734

(57) ABSTRACT

The invention relates to a method for treating a plant wherein an agrochemical composition is applied onto at least one part of said plant, wherein the plant is corn or soy and wherein the agrochemical composition comprises in a liquid medium:
particles of at least one inorganic phosphor exhibiting:
   a maximum in the emission spectrum in the range of wavelengths between 400 nm and 500 nm;
   an absorption Abs in the visible range which is equal to or less than 15.0%, preferably equal to or less than 10.0%, even more particularly equal to or less than 3.0%; and
   an internal quantum efficiency (IQE) measured in the range of wavelengths between 300 nm and 410 nm which is equal to or greater than 50.0%, more particularly greater than 75.0%, even more particularly greater than 90.0%;
      and
optionally at least one biocide.

The present application claims the priority of European patent application EP 19315166.9 filed on 19 Dec. 2019, the content of which being entirely incorporated herein by reference for all purposes. In case of any incoherency between the present application and the EP application that would affect the clarity of a term or expression, it should be made reference to the present application only.

The present invention relates to a method for treating corn and soy wherein an agrochemical composition comprising particles of at least one inorganic phosphor in a liquid medium is applied onto at least one part of the plant.

### FIELD OF THE INVENTION AND TECHNICAL PROBLEM TO BE SOLVED

With the increase of the worldwide population, there is a continuous need for providing improved compositions for agriculture needs. Such agrochemical compositions should be efficient in terms of promoting plant growth and increasing crop yields. There is therefore a general desire to obtain a high crop productivity.

To improve said productivity, organic products have been used quite heavily to increase crop productivity but concerns have been raised about the long-term effects of these products on mammals, especially on humans. There is a therefore also a need for improving the productivity of crops with the help of a product without any concerns about the long-term effects of said product.

The present invention aims at solving this technical problem. Indeed, the inventors of the present application have now discovered that an agrochemical composition comprising particles of an inorganic phosphor in a liquid medium exhibits excellent results in crop yield for two plants: corn (aka maize or Zea mays) and soy.

### TECHNICAL BACKGROUND

CN 107556611 discloses a polymeric film comprising a light conversion agent, to help the growth of plant. WO 2015/044261 discloses a polymeric film comprising particles of an inorganic phosphor. WO 2012/091813 discloses a process to maximize plant growth with the help of a LED comprising phosphor particles.

In the article “Red-emitting Ca₁₋ₓSrₓS:Eu²⁺ Phosphors as Light Converters for Plant-growth Applications” (2011 MRS Spring Meeting Manuscript ID: MRSS11-1342-V04-04.R1), the prepared phosphors are coated on a high reflective aluminum.

The process of the invention whereby a blue emitting phosphor is applied on corn or soy is not disclosed in these documents.

### BRIEF DESCRIPTION OF THE INVENTION

The inventions are disclosed in one of claims 1 to 18.

The invention thus relates to a method for treating a plant wherein an agrochemical composition is applied onto at least one part of said plant, wherein the plant is corn or soy and wherein the agrochemical composition comprises in a liquid medium:
particles of at least one inorganic phosphor exhibiting:
   a maximum in the emission spectrum in the range of wavelengths between 400 nm and 500 nm;
   an absorption Abs in the visible spectrum which is equal to or less than 15.0%, preferably equal to or less than 10.0%, even more particularly equal to or less than 3.0%; and
   an internal quantum efficiency (IQE) measured in the range of wavelengths between 300 nm and 410 nm which is equal to or greater than 50.0%, more particularly equal to or greater than 75.0%, even more particularly equal to or greater than 90.0%;

and
optionally at least one biocide.

More particularly, the invention also relates to a method for treating a plant wherein an agrochemical composition is applied onto at least one part of said plant, wherein the plant is corn or soy and wherein the agrochemical composition comprises in a liquid medium:
particles of any one of the inorganic phosphors disclosed below;

and
optionally at least one biocide.

The invention also relates to a method for increasing the crop yield of a plant consisting in applying onto at least one part of said plant, an agrochemical composition comprising in a liquid medium:
particles of at least one inorganic phosphor exhibiting:
   a maximum in the emission spectrum in the range of wavelengths between 400 nm and 500 nm;
   an absorption Abs in the visible spectrum which is equal to or less than 15.0%, preferably equal to or less than 10.0%, even more particularly equal to or less than 3.0%; and
   an internal quantum efficiency (IQE) measured in the range of wavelengths between 300 nm and 410 nm which is equal to or greater than 50.0%, more particularly equal to or greater than 75.0%, even more particularly equal to or greater than 90.0%;

and
optionally at least one biocide;

wherein the plant is corn or soy.

More particularly, the invention also relates to a method for increasing the crop yield of a plant consisting in applying onto at least one part of said plant, an agrochemical composition comprising in a liquid medium:
particles of any one of the inorganic phosphors disclosed below; and
optionally at least one biocide;

wherein the plant is corn or soy.

The agrochemical composition is applied onto at least one part of said plant. It is advantageously applied onto at least one part of the surface of said plant. It is preferably applied onto the foliar system of the plant.

In a general manner, the agrochemical composition can be easily applied using any conventional technique, such as spraying. For instance, the agrochemical composition may be sprayed onto the leaves of the plant. To do so, any commercially available equipment may be used.

The agrochemical composition used in the present invention comprises:
a liquid medium; and
particles of at least one inorganic phosphor; and
optionally at least one biocide.

said inorganic phosphor exhibiting:
a maximum in the emission spectrum in the range of wavelengths between 400 nm and 500 nm;
an absorption Abs in the visible spectrum which is equal to or less than 15.0%, preferably equal to or less than 10.0%, even more particularly equal to or less than 3.0%; and
an internal quantum efficiency (IQE) measured in the range of wavelengths between 300 nm and 410 nm which is equal to or greater than 50.0%, more particularly equal to or greater than 75.0%, even more particularly equal to or greater than 90.0%.

More particularly, the agrochemical composition comprises:
a liquid medium; and
particles of any one of the inorganic phosphors disclosed below; and
optionally at least one biocide.

The present invention also concerns the use of such an agrochemical composition for treating corn or soy.

### DESCRIPTION OF THE INVENTION

More details about the inventions are now provided. The present invention provides an agrochemical treatment of plants which is very effective in terms of increasing plant growth and development, and which leads to improved yields.

In one embodiment, the present invention provides an agrochemical treatment of plants which improves the health of plants, more particularly of corn or soy. Healthy plants are more resilient to environmental stress and changes in climates (in particular, they can be more drought tolerant). Healthy plants are also more resilient to pest pressure and generally exhibit enhanced disease resistance. Improving plant health results thus in increased yields.

Furthermore, the agrochemical composition used in the present invention has excellent physicochemical properties and in particular an improved stability on storage. The particles of the inorganic phosphor have also less impact on the environment than organic molecules usually used in the agrochemical compositions commonly used (e.g. reduced long-term effects on mammals, especially on humans).

About the Inorganic Phosphor

The inorganic phosphor is characterized by an emission in the blue. The inorganic phosphor may thus be defined as a “blue emitting phosphor”. It exhibits a maximum in the emission spectrum in the range of wavelengths between 400 nm and 500 nm. This maximum is determined with an excitation spectrum measured with a spectrofluorometer. It is convenient to use a spectrofluorometer equipped with two monochromators which allows to record both an excitation spectrum and an emission spectrum. An example of such a spectrofluorometer is the Fluoromax 4 commercialized by HORIBA, Ltd. Information about this appliance may be found at the a following address: http://www.horiba.com/fr/scientific/products/fluorescence-spectroscopy/steady-state/fluoromax/fluoromax-series-524/.

The inorganic phosphor is selected so as to absorb little or not at all in the visible spectrum (400-800 nm). The inorganic phosphor has an absorption Abs in the visible spectrum which is equal to or less than 15.0% (≤15.0%), preferably equal to or less than 10.0%, even more particularly equal to or less than 3.0%. The absorption is determined according to methods well known in the field of phosphors. According to an embodiment, the following method is used. The absorption spectrum is measured using a spectrofluorometer including two monochromators working in a synchronous mode. The spectra of a white reference (BaSO₄), of a black reference (carbon black) and of the inorganic phosphor are recorded between 250 nm and 410 nm. For each value of the wavelength λ, the absorption Abs is calculated with the following formula:

Abs(λ)=(A_{white}−Aₛₐₘₚₗₑ)/(A_{white}−A_{black})×100

Then the curve Abs vs λ is plotted.

The inorganic phosphor is also characterized by a high efficiency of the conversion of the UV light into visible light. Thus, the inorganic phosphor exhibits an internal quantum efficiency (IQE) measured in the range of wavelengths between 300 nm and 410 nm which is equal to or greater than 50.0% (≥50.0%), more particularly equal to or greater than 75.0%, even more particularly equal to or greater than 90.0%. The IQE corresponds to the ratio of the number of photons emitted by the inorganic phosphor to the number of photons absorbed by said phosphor. The IQE is measured according to techniques well known to the skilled person. The IQE is measured with a spectrofluorometer equipped with an integration sphere. BaSO₄ is used as the standard light reflector. The IQE may be measured with the following appliance: Fluoromax 4 commercialized by HORIBA, Ltd. Information about this appliance may be found at the a following address: http://www.horiba.com/fr/scientific/products/fluorescence-spectroscopy/steady-state/fluoromax/fluoromax-series-524/.

The inorganic phosphor that is used in the present invention may be selected in the group consisting of europium-doped and/or cerium-doped aluminates; europium-doped phosphates; europium-doped halo-phosphates; europium-doped halo-silicates; europium-doped or cerium-doped silicates; europium-doped or cerium-doped nitrides and europium-doped or cerium-doped oxynitrides. It may be any one of the blue emitting phosphor disclosed in Table I of ECS Journal of Solid State Science and Technology 2013, 2(2), R3119-R3131.

The inorganic phosphor may be more particularly selected in the group consisting of the europium-doped and/or cerium-doped aluminates of formula (I):

a(M_{1-d}M¹_{d}O).b(Mg₁₋ₑM²ₑO).c(Al₂O₃) (I)

wherein
M denotes at least one element selected from the group consisting of Ba, Sr and Ca;
M¹ denotes Eu and/or Ce;
M² denotes at least one element selected from the group consisting of Zn and Co;

and wherein a, b, c, d and e satisfy the following relationships: 0.25≤a≤2.00; 0<b≤2.00; 3.00≤c≤9.00; 0≤d≤0.40 and 0≤e≤0.60.

M¹ may be more particularly Eu.

More particularly,
M is Ba;
M¹ is Eu;
a=b=1;
c=5 or c=7;
e=0;
0.05≤d≤0.40.

The preparation of the aluminate of formula (I) is known to the skilled person and described inter alia in WO 2015/044261.

The inorganic phosphor may be more particularly selected in the group consisting of the europium-doped aluminates of formula (II):

A¹MgAl₁₀O₁₇ (II)

wherein A¹ represents at least one of Ba, Sr, or Ca alone or in combination.

The following europium-doped aluminates may be used: BaMgAl₁₀O₁₇:Eu²⁺; Ba_{0.9}Eu_{0.1}MgAl₁₀O₁₇; Ba_{0.8}Eu_{0.2}MgAl₁₀O₁₇; or Ba_{0.9}Eu_{0.1}MgAl₁₄O₂₃.

The inorganic phosphor may be more particularly selected in the group consisting of the europium-doped phosphates of formula (III):

ABPO₄ (III)

wherein:
A denotes an element selected from the group consisting of Li, Na and K;
B denotes an element selected from the group consisting of Ca, Mg, Ba and Sr.

The following phosphors that may be used are the following europium-doped phosphates of formula: LiCaPO₄, LiSrPO₄, LiBaPO₄, NaBaPO₄, KCaPO₄, KSrPO₄, KBaPO₄, NaMgPO₄ (see Luminescence 2010, 25(5), 364-6 “Synthesis and luminescence properties of a novel blue emitting phosphor NaMgPO₄:Eu²⁺”).

The inorganic phosphor may be more particularly selected in the group consisting of the europium-doped phosphates of formula (IV):

SrB₂(PO₄)₂ (IV)

wherein B denotes Mg or Zn.

The following phosphors that may be used are the following europium-doped phosphates of formula: Ca₃Mg₃(PO₄)₄; SrMg₂(PO₄)₂ or SrZn₂(PO₄)₂.

The inorganic phosphor may be more particularly selected in the group consisting of the europium-doped phosphates of formula (V):

B₂P₂O₇ (V)

wherein B denotes Ca or Sr.

The following phosphors that may be used are the following europium-doped phosphates of formula: Ca₂P₂O₇; Sr₂P₂O₇.

The inorganic phosphor may be more particularly selected in the group consisting of the europium-doped halo-phosphates of formula (VIa) or (VIb):

A₂PO₄Cl (VIa)

A₅(PO₄)₃Cl (VIb)

wherein A denotes an element selected from the group consisting of Ca and Sr.

The following phosphors that may be used are the following europium-doped halo-phosphates of formula: Ca₂PO₄Cl; Ca₅(PO₄)₃Cl; Sr₅(PO₄)₃Cl.

The inorganic phosphor may be more particularly selected in the group consisting of the europium-doped silicates of formula (VIIa) to (VIId):

A₃MgSi₂O₈ (VIIa)

A₂MgSi₂O₇ (VIIb)

AMgSi₂O₆ (VIIc)

Li₂ASiO₄ (VIId)

wherein A denotes an element selected from the group consisting of Ba, Ca and Sr

and the cerium-doped silicate of formula (VIIe):

BaY₂Si₃O₁₀ (VIIe)

The following phosphors that may be used are the following europium-doped silicates of formula: Ba₃MgSi₂O₈; Sr₃MgSi₂O₈; Ca₃MgSi₂O₈; Sr₂MgSi₂O₇; CaMgSi₂O₆; Li₂CaSiO₄; Li₂BaSiO₄.

The following phosphors that may be used are the following europium-doped oxynitride of formula BaSi₃Al₃O₄N₅, the following cerium-doped nitride of formula LaSi₃N₅ and the following cerium-doped oxynitride of formula LaAl(Si₅Al)(N₉O).

The particles of the inorganic phosphor are preferably such that the composition remains stable over a certain period of time. The particles of the inorganic phosphor typically exhibits a D50 between 100 nm and 20.0 μm. D50 may be more particularly between 500 nm and 15.0 μm, even more particularly between 500 nm and 10.0 μm or between 1.0 μm and 10.0 μm. D50 has the usual meaning used in statistics. D50 corresponds to the median value of the distribution. It represents the particle size such that 50% of the particles are less than or equal to the said size and 50% of the particles are higher than or equal to said size. D50 is determined from a distribution of size of the particles (in volume) obtained with a laser diffraction particle size analyzer. The appliance LA-920 of HORIBA, Ltd. may be used.

The particles of the inorganic phosphor are dispersed in a liquid medium. The liquid medium preferably comprises water. The liquid medium may be water or a mixture of water and at least one organic fluid.

The organic liquid may be water-miscible or not. When the liquid medium contains water and at least one water-immiscible organic fluid, said liquid medium may be in the form of an emulsion. The organic fluid can be selected in the group consisting of natural or synthetic oils, in particular mineral oils, vegetable oils, fatty or non fatty alcohols, fatty acids, esters containing at least one fatty acid and/or at least one fatty alcohol. The fatty alcohols and fatty acids mentioned above are those which contain from 8 to 32, preferably from 10 to 26 and more preferentially from 12 to 22 carbon atoms.

The organic fluid when used is preferably water-miscible in any proportion. It can in particular be chosen from mono-alcohols containing from 2 to 5 carbon atoms, such as ethanol or isopropanol and from polyols such as glycol, glycerol, saccharides such as sorbitol. It is of course possible to use a combination of organic fluids and in particular any combination of any of the organic fluids described above.

According to one particularly preferred embodiment, the liquid medium of the present invention is water, because it is safe and environmentally friendly.

The agrochemical composition advantageously contains at least 25.0 wt %, more particularly at least 30.0 wt %, more particularly at least 40.0 wt %, and even more preferentially at least 50.0 wt %, of water, relative to the total weight of said composition.

When one or more organic fluids are present in the composition, said composition preferably contains from 0.005 wt % to 0.2 wt %, more particularly from 0.01 wt % to 0.1 wt % of organic fluid(s), relative to the total weight of the composition.

The agrochemical composition typically comprises between 5.0 wt % and 75.0 wt % of particles of the inorganic phosphor. This proportion may be between 5.0 wt % and 50.0 wt %, more particularly between 10.0 wt % and 25.0 wt %.

The agrochemical composition may also further comprise at least one surfactant. Surfactants are compounds that lower the surface tension (or interfacial tension) between two liquids, between a gas and a liquid, or between a liquid and a solid. Surfactants may act as detergents, wetting agents, emulsifiers, foaming agents, and dispersants. Examples of surfactants are provided in ex. 1. The surfactant may be selected from the group consisting of betaines, amine oxides, ethoxylated fatty amines, fatty amines, ether carboxylates, polycarboxylates, polyacrylates, acid or non acid mono- and di-ester phosphates, optionally polyalkoxylated, alkylmonoglycosides, alkylpolyglycosides, and mixtures thereof.

The betaine surfactants are in particular those described in WO 2006/069794. Preferably, the betaine surfactants are chosen from the betaines having formula R₁R₂R₂N⁺—CH₂COO⁻ (VIII), the betaines having formula R₁—CO—NH—R₄R₂R₂N⁺—CH₂COO— (IX), and mixtures thereof, wherein the R₁ group is a linear or branched hydrocarbon group, preferably an alkyl group containing 2 to 30 carbon atoms, preferably 2 to 24 carbon atoms, preferably 3 to 20 carbon atoms; the R₂ groups which are identical or different, are a C₁-C₃ alkyl group, preferably a methyl group, and the R₄ group is a divalent linear or branched hydrocarbon group containing 1 to 6 carbon atoms, optionally substituted with a hydroxyl group, preferably a group of formula —CH₂—CH₂—CH₂— or —CH₂—CHOH—CH₂—. Preferably, in formulae (VIII) and (IX) above, R₂ is a methyl group. R₁ is preferably an alkyl group. This group is usually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R₁ group refers to the number of carbon atoms of the two most represented species. The preferred betaine surfactants are those wherein R₂ is a methyl group, R₁ is a lauryl alkyl group mixture, preferably having more than 50% by weight of C12 and R₄ if present is —CH₂—CH₂—CH₂—.

Betaines of formula (VIII) are preferred. They are often referred to as alkyl betaines, and are preferably an alkyldimethyl betaine based surfactant, for example lauryl dimethyl betaine based surfactant (R₂ is a methyl group and R₁ is a lauryl C₁₂ group).

Betaines of formula (IX) are often referred to as alkyl amidoalkyl betaines.

The amine oxide surfactants which may be used in the present invention are in particular those described in WO 2006/069794. Such amine oxides surfactants can be chosen from the amine oxides having formula R₁R₂R₂N→O (X), the amine oxides having formula R₁—CO—NH—R₄R₂R₂N→O (XI), and mixtures thereof, wherein R₁, R₂ and R₄ are as described in formulae (VIII) and (IX) above.

In formulas (X) and (XI) above, the R₂ group is preferably a methyl group. R₁ is preferably an alkyl group. This group is usually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R₁ group refers to the number of carbon atoms of the two most represented species. The preferred amine oxide surfactants are those wherein R₂ is a methyl group, R₁ is a lauryl alkyl group mixture, preferably having more than 50% by weight of C12 and R₄ if present is —CH₂—CH₂—CH₂—.

Amine oxides of formula (X) are preferred. They are often referred to as alkyl amine oxides, and are preferably an alkyldimethyl amine oxide based surfactant, for example lauryl dimethyl amine oxide based surfactant (R₂ is a methyl group and R₁ is a lauryl C12 group).

Amine oxides of formula (XI) are often referred to as alkyl amidoalkyl amine oxides.

The fatty amines or ethoxylated fatty amines useful as surfactants in the present invention may comprise at least one hydrocarbon group containing 2 to 24 carbon atoms, optionally polyalkoxylated. The fatty amines or ethoxylated fatty amines may more particularly be selected from amines comprising at least one linear or branched, saturated or unsaturated group containing 2 to 24 carbon atoms, preferably 8 to 18 carbon atoms, optionally comprising 2 to 30 oxyethylene groups, or a mixture of a plurality thereof. Examples include ethoxylated tallow amines. The fatty amines or ethoxylated fatty amines may be selected from ethoxylated fatty amines comprising at least one or several, linear or branched, saturated or unsaturated, group(s) containing 6 to 24 carbon atoms, preferably 8 to 20 carbon atoms, comprising 2 to 30 oxyethylene groups, or mixtures thereof.

Examples include the compounds having the following formula (XII):

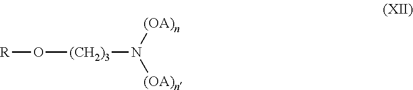

wherein R represents a linear or branched, saturated or unsaturated hydrocarbon group containing 6 to 24 carbon atoms, preferably 8 to 20 carbon atoms; OA represents an oxyalkylene group; and n, n′, which may or may not be identical, represent a mean number in the range 1 to 30. Examples of such amines to be cited are amines derived from copra and containing 5 oxyethylene (OE) units, oleic amines containing 5 OE, amines derived from tallow containing 5 to 20 OE, for example 10 OE, compounds corresponding to the above formula in which R is an alkyl group containing 12 to 15 carbon atoms and the total number of OE units is in the range 20 to 30.

The ether carboxylates useful as surfactants in the present invention preferably have the following formula (XIII): R(OCH₂CH₂)ₙOCH₂CO₂, wherein R is a linear or branched alkyl, alkenyl, alkylphenyl or polypropyleneoxy group having from 6 to 20, for example 8 to 14, aliphatic carbon atoms and n is a number ranging of from 1 to 30, preferably of from 2 to 20. The ether carboxylate has preferably a counter ion being ammonium or potassium, or obtained from an amine or alkanolamine having up to 6 carbon atoms.

The polycarboxylate polymers are advantageously sodium polycarboxylates.

Polyacrylates polymers act as dispersants. A dispersant is a substance added to a suspension, usually a colloid, to improve the separation of particles and to prevent settling or clumping. In the present invention, dispersants stabilize the dispersion and avoid any sedimentation of the particles of phosphor.

The optionally polyalkoxylated acid or non acid mono- and di-ester phosphates useful as surfactants in the present invention are selected from acid or non acid phosphate mono- or di-esters, optionally polyalkoxylated, having the following formula (XIV):

(A)₃-mP(═O)(OM)ₘ (XIV)

wherein:
A, identical or different, represents a group R′₁—O(CH₂—CHR′₂—O)n wherein:

R′₁ represents a linear or non-linear, saturated or unsaturated C6-C20 hydrocarbon group, preferably C8-C18;

R′₂ represents a hydrogen atom or a methyl or ethyl group, preferably a hydrogen atom;

n is a mean number of motifs in the range 0 to 10, preferably in the range 2 to 10;
M represents a hydrogen atom, an alkali or alkaline-earth metal, a N(R₃)₄⁺ type radical wherein the R₃ groups, identical or different, represents a hydrogen atom or a linear or non-linear, saturated or unsaturated C₁-C₆ hydrocarbon group optionally substituted with a hydroxyl group;
m is a whole or average number in the range 1 to 2.

The acid or non acid mono- and di-ester phosphate, optionally polyalkoxylated may be in the form of a monoester, a diester, or a mixture of these two esters.

The preferred surfactants are those that act as dispersants. They are notably chosen from non-ionic surfactants such as polyacrylates.

When the agrochemical composition comprises one or more surfactants, the total amount of said surfactant(s) preferably ranges from 0.05 wt % to 15.0 wt %, preferably from 0.1 wt % to 10.0 wt %, more preferably from 0.3 wt % to 5.0 wt %, based on the total weight of the composition.

According to a preferred embodiment, the agrochemical composition may further contains at least one thickening agent. Suitable thickening agent can be in particular chosen from polysaccharides such as for example xanthan gum, alginates, carboxylated or hydroxylated methylcelluloses, synthetic macromolecules of the polyacrylate, polymaleate, polyvinylpyrrolidone, polyethylene glycol or polyvinyl alcohol type. When the agrochemical composition comprises one or more thickening agents, the total amount of thickening agent(s) preferably ranges from 0.05 wt % to 5.0 wt %, preferably from 0.1 wt/o to 2.0 wt % by weight, based on the total weight of the composition.

The agrochemical composition may further contain one or more fertilizers, preferably chosen from water-soluble fertilizers such as for example foliar fertilizers (fertilizers which are taken up by the leaves of the plants), such as urea or foliar macro- or microelement fertilizer, including chelates.

The agrochemical composition may further contain additional ingredients, which can be chosen from all additives and adjuvants useful in agrochemical compositions such as for example nutrients, anti-foaming agents, colorants such as pigments, etc.

According to a preferred embodiment, the agrochemical composition further contains at least one biocide. A biocide is a chemical substance capable of killing living organisms. Usually biocides are divided in two sub-groups:
pesticides, which includes herbicides, insecticides and insect repellants, fungicides, rodenticides, algicides, moluscicides and miticides;
antimicrobials, which includes germicides, antibiotics, antibacterials, antivirals, antifungals, antiprotozoals and antiparasites.

The biocide may more particularly be a pesticide, more particularly a fungicide.

Useful biocides may be chosen, in a non-limitative manner, among the following compounds: triazine herbicides, sulfonylurea herbicides, uracils, urea herbicides, acetanilide herbicides, organophosphonate herbicides, glyphosate salts, glyphosate esters, nitrilo oxime fungicides, imidazole fungicides, triazole fungicides, sulfenamide fungicides, dithio-carbamate fungicides, chlorinated aromatic, dichloro aniline fungicides, strobilurin fungicides, succinate dehydrogenase inhibitors, biofungicides, carbamate insecticides, organo thiophosphate insecticides; perchlorinated organic insecticides, phenylpyrazole insecticides such as fipronil, methoxychlor, miticides, propynyl sulfite, triazapentadiene miticides, chlorinated aromatic miticides, tetradifan, dinitrophenol miticides, binapacryl, thiophanate-methyl and mixtures thereof.

The biocide preferably is a pesticide, and more preferably a pesticide selected from herbicides, insecticides and fungicides. According to a particularly preferred embodiment, the composition contains at least one fungicide, and most preferably at least one fungicide selected from strobilurin fungicides, triazole fungicides, dithio-carbamate fungicides, succinate dehydrogenase inhibitors, biofungicides, and mixtures thereof.

Among the strobilurin fungicides useful in the present invention, azoxystrobin and pyraclostrobin are especially preferred. Among the triazole fungicides, prothioconazole and epoxiconazole are preferred. Among the dithio-carbamate fungicides, mention can be made in particular of mancozeb. The succinate dehydrogenase inhibitors useful in the present invention are especially chosen from pyrazole-carboxamide fungicides. Among the latter ones, fluxapyroxad, benzovindiflupyr and bixafen are preferred. The biofungicides are bacteria having antifungal properties. Among them, mention shall be made in particular of Bacillus subtilis.

According to a preferred embodiment, said one or more fungicide(s) is chosen from the group consisting of strobilurin fungicides, triazole fungicides, succinate dehydrogenase inhibitors, and mixtures thereof, more preferably from pyrazole-carboxamide fungicides, even more preferably from fluxapyroxad, benzovindiflupyr, bixafen and mixtures thereof, and most preferably fluxapyroxad.

The fungicide may also be a combination of two or more of the fungicides selected in the previous list. For instance, the fungicide may correspond to the combination of pyraclostrobin, epoxiconazole and fluxapyroxad.

### EXAMPLES

Preparation of an Aqueous Dispersion of Particles of BAM (Dispersion DA)

An aqueous dispersion of particles of BAM of formula Ba_{0.9}Eu_{0.1}MgAl₁₀O₁₇ was prepared with the quantities given in Table I, using the following protocol:
Rhodoline 226/35 was added in water and mixed until an homogeneous solution is obtained;
then, the BAM particles were added and mixed until the dispersion is homogeneous;
finally, Rhodopol 23 was added and mixed until the dispersion is homogeneous. The mechanical agitator used was a IKA RW20 model with naval propeller stirrer.

The BAM used exhibits the following properties:
an internal quantum efficiency (IQE) which is 95%;
an absorption Abs which is 98% at 320 nm; and
a maximum in the emission spectrum at 450 nm.

TABLE I

| | Chemical | | | Quantity | |
|---|---|---|---|---|---|
| Component | Name | Supplier | Role | (g) | wt % |
| BAM | | Solvay | active | 264 | 22% |
| | | | ingredient | | |
| Rhodoline | acrylic | Solvay | dispersant | 24 | 2% |
| 226/35 | polymer | | | | |
| | solution | | | | |
| Rhodopol | xanthan | Solvay | rheology | 168 | 14% |
| 23 (2 wt % | gum | | modifier | | |
| in water) | | | | | |
| water | — | — | liquid | 744 | 62% |
| | | | medium | | |

### Example A: Process According to the Invention (Corn)

The experiments were performed on corn. Sowing of the seeds began in March in Brazil:
seeds: K9105 VIP3 from KVS (more information on: https://www.kws-sementes.com.br/aw/Produtos/Milho/K-9105-VIP3/˜ieni/);
distribution of 4 seeds/meter;
depth of 5 cm.

The experiments disclosed in Table II were performed:
with no fungicide and no BAM: see comp. ex. A1;
with a dispersion (noted DO) containing a fungicide but no BAM: see comp. ex. A2;
with a dispersion (noted D1) containing a fungicide and various amounts of BAM. D1 was obtained by mixing D0 and variables amounts of DA.

Composition of the Agrochemical Composition D0
0.8 L/ha of a fungicide composition commercialized by BASF under the brand Ativum. This fungicide composition contains 81 g/L of pyraclostrobin (CAS No 175013-18-0), 50 g/L of epoxiconazole (CAS No 133855-98-8) and 50 g/L of fluxapyroxad (CAS No 907204-31-3);
0.5 L/ha of mineral oil which is an adjuvant for the fungicide is commercialized by BASF under the brand Assist;
100 L/ha of water.

Composition of the Agrochemical Composition D1
0.8 L/ha of Ativum;
0.5 L/ha of Assist;
dispersion A (various amounts);
100 L/ha of water.

The agrochemical compositions were sprayed on corn (one foliar application done together with the fungicide at 50 days after planting). The amount of corn harvested was determined after the crop.

TABLE II

| | | amount of | | |
|---|---|---|---|---|
| | | dispersion DA | bags of | increase |
| Examples | dispersion | sprayed (L/ha) | corn per ha | yield (%) |
| comp. | none | / | 68.8 | |
| ex. A1 | | | | |
| comp. | D0 (fungicide | / | 84.8 | 0% |
| ex. A2 | only) | | | |
| Ex. A1 | D1 (fungicide + | 0.5 | 87.5 | 3% |
| | BAM) | | | |
| Ex. A2 | D1 (fungicide + | 1.0 | 92.1 | 9% |
| | BAM) | | | |
| Ex. A3 | D1 (fungicide + | 1.5 | 90.5 | 7% |
| | BAM) | | | |
| Ex. A4 | D1 (fungicide + | 2.0 | 89.7 | 6% |
| | BAM) | | | |

As can be seen with the results of Table II, an increase of the yield (3-9%) is observed with dispersions A1-A4 containing both the fungicide and BAM.

### Example B: Process According to the Invention (Soy)

The experiments were performed on soy. The amount of soy harvested was determined after the crop. Sowing of the seeds began in October in Brazil:
seeds: Monsoy 5917 (more information on: https://www.monsoy.com.br/pt-br/variedades/variedades/variedades-detail-template.html/m5917ipro.html)
distribution of 12 seeds/meter;
depth of 3 cm.

TABLE III

| | | amount of | | |
|---|---|---|---|---|
| | | dispersion DA | bags of | increase |
| Examples | dispersion | sprayed (L/ha) | soy per ha | yield (%) |
| Comp. | none | / | 46.8 | / |
| ex. B1 | | | | |
| Comp. | D0 (fungicide | / | 64.2 | / |
| ex. B2 | only) | | | |
| Ex. B1 | DA (BAM only) | 1.0 | 64.6 | 38% |
| | | | | compared to |
| | | | | Comp ex. B1 |
| Ex. B2 | D1 (fungicide + | 0.25 | 65.2 | 1.6% |
| | BAM) | | | compared to |
| | | | | Comp ex. B2 |
| Ex. B3 | D1 (fungicide + | 0.5 | 65.8 | 2.5% |
| | BAM) | | | compared to |
| | | | | Comp ex. B2 |
| Ex. B4 | D1 (fungicide + | 1.0 | 72.1 | 12.3% |
| | BAM) | | | compared to |
| | | | | Comp ex. B2 |

As can be seen with the results of Table III, the dispersion of BAM alone improves the yield (Ex. B1) in a comparable way to the fungicide (Comp. ex. B2). The combination of the fungicide and BAM also leads to a synergy (see ex. B4 and ex. B1).

1. A method for treating a plant comprising applying an agrochemical composition to the plant wherein an agrochemical composition is applied onto at least one part of said plant, wherein the plant is corn or soy and wherein the agrochemical composition comprises in a liquid medium:
particles of at least one inorganic phosphor exhibiting:
a maximum in emission spectrum in range of wavelengths between 400 nm and 500 nm;
an absorption Abs in visible spectrum which is equal to or less than 15.0%; and
an internal quantum efficiency (IQE) measured in the range of wavelengths between 300 nm and 410 nm which is equal to or greater than 50.0%;
and
optionally at least one biocide.

2. A method for increasing crop yield of a plant consisting in applying onto at least one part of said plant, an agrochemical composition comprising in a liquid medium:
particles of at least one inorganic phosphor exhibiting:
a maximum in emission spectrum in range of wavelengths between 400 nm and 500 nm;
an absorption Abs in visible spectrum which is equal to or less than 15.0%; and
an internal quantum efficiency (IQE) measured in the range of wavelengths between 300 nm and 410 nm which is equal to or greater than 50.0%;
and
optionally at least one biocide;
wherein the plant is corn or soy.

3. The method according to claim 1 wherein the inorganic phosphor is selected in the group consisting of europium-doped and/or cerium-doped aluminates; europium-doped phosphates; europium-doped halo-phosphates; europium-doped halo-silicates; europium-doped or cerium-doped silicates; europium-doped or cerium-doped nitrides and europium-doped or cerium-doped oxynitrides.

4. The method according to claim 1 wherein the inorganic phosphor is:
an europium-doped and/or cerium-doped aluminate of formula (I):
a(M_{1-d}M¹_{d}O).b(Mg₁₋ₑM²ₑO).c(Al₂O₃) (I)
wherein
M denotes at least one element selected from the group consisting of Ba, Sr and Ca;
M¹ denotes Eu and/or Ce;
M² denotes at least one element selected from the group consisting of Zn and Co;
and wherein a, b, c, d and e satisfy following relationships: 0.25≤a≤2.00; 0<b≤2.00; 3.00≤c≤9.00; 0≤d≤0.40 and 0≤e≤0.60;
or
an europium-doped aluminate of formula (II):
A¹MgAl₁₀O₁₇ (II)
wherein A1 represents at least one of Ba, Sr, or Ca alone or in combination;
or
an europium-doped phosphate of formula (III):
ABPO₄ (III)
wherein:
A denotes an element selected from the group consisting of Li, Na and K;
B denotes an element selected from the group consisting of Ca, Mg, Ba and Sr;
or
an europium-doped phosphate of formula (IV):
SrB₂(PO₄)₂Eu²⁺ (IV)
wherein B denotes Mg or Zn;
or
an europium-doped compound of formula (V):
B₂P₂O₇Eu²⁺ (V)
wherein B denotes Ca or Sr;
or
an europium-doped halo-phosphate of formula (VIa) or (VIb):
APO₄Cl (VIa)
A₅(PO₄)₃Cl (VIb)
wherein A denotes an element selected from the group consisting of Ca and Sr;
or
an europium-doped silicate of formula (VIIa) to (VIId):
A₃MgSi₂O₈ (VIIa)
A₂MgSi₂O₇ (VIIb)
AMgSi₂O₆ (VIIc)
Li₂ASiO₄ (VIId)
wherein A denotes an element selected from the group consisting of Ba, Ca and Sr;
or
the cerium-doped silicate of formula BaY₂Si₃O₁₀ (VIIe).

5. A method for treating a plant wherein an agrochemical composition is applied onto at least one part of said plant, wherein the plant is corn or soy and wherein the agrochemical composition comprises in a liquid medium:
particles of one of the inorganic phosphor as defined in claim 4;
and
optionally at least one biocide.

6. A method for increasing crop yield of a plant consisting in applying onto at least one part of said plant, an agrochemical composition comprising in a liquid medium:
particles of one of the inorganic phosphor as defined in claim 4;
optionally at least one biocide;
wherein the plant is corn or soy.

7. The method according to claim 1 wherein the agrochemical composition is applied onto a foliar system of the plant.

8. The method according to claim 1 wherein the agrochemical composition is sprayed onto leaves of the plant.

9. The method according to claim 1 wherein the liquid medium is water or a mixture of water and at least one organic fluid.

10. The method according to claim 9 wherein the organic fluid is selected in the group consisting of natural or synthetic oils, in particular mineral oils, vegetable oils, fatty or non fatty alcohols, fatty acids, esters containing at least one fatty acid and/or at least one fatty alcohol.

11. The method according to claim 1 wherein the agrochemical composition further comprises at least one surfactant.

12. The method according to claim 1 wherein the agrochemical composition is in a form of a dispersion.

13. The method according to claim 1 wherein the particles of the inorganic phosphor exhibits a D50 between 100 nm and 20.0 μm.

14. The method according to claim 1 wherein the liquid medium is an emulsion.

15. (canceled)

16. (canceled)

17. (canceled)

18. (canceled)
